(19) United States
(12) Patent Application Publication
(10) Pub. No.: US 2020/0374623 A1
(43) Pub. Date: Nov. 26, 2020

(54) AUDIO PLAYER WITH ENCLOSURE OPTIONS

(71) Applicant: MOREL, Ness Ziona (IL)

(72) Inventor: Oren MORDECHAI, Ramat Hasharon (IL)

(21) Appl. No.: 16/763,720

(22) PCT Filed: Nov. 14, 2018
(86) PCT No.: PCT/IL2018/051225

§ 371 Date: May 13, 2020

Related U.S. Application Data
(60) Provisional application No. 62/586,219, filed on Nov. 15, 2017.

(51) Int. Cl. H04R 1/28

(52) U.S. Cl. CPC H04R 1/2811; H04R 2420/07

(57) ABSTRACT

The disclosed technology relates to a multi-use audio player, and more particularly, to an audio player with the ability to switch between a fully operational portable stand-alone audio player that is open baffle (box-less), and an audio player that can serve as a closed baffle audio driver module when placed in an enclosure.

### FIELD OF THE DISCLOSED TECHNOLOGY

The disclosed technology relates to an audio player and more particularly a multi-use audio player. The audio player is a fully operational portable stand-alone audio player that is open baffle (box-less) and closed baffle (audio driver module) when placed in an enclosure. The audio player switches between a closed baffle audio system when placed in an enclosure, or an open baffle system when free standing.

### BACKGROUND OF THE DISCLOSED TECHNOLOGY

Short-range wireless and wired audio players are well known in the art. Bluetooth® is one standard for short-range wireless interconnection of electronic devices. Bluetooth® players are speakers or drivers that have the ability to connect to the music source audio signal through short-range wireless interconnection. Any wireless system would work for the present disclosed technology. Audio drivers have a few options for housing most of which are closed baffle audio driver systems and are in some type of boxed enclosure. The primary role of the enclosure is to prevent destructive wave interference of the sound waves emanating from front facing surface of an audio player by the rear facing sound waves.

In contrast, open baffle audio drivers or speakers do not have an enclosure and sound waves emanating from the front and rear provide 360 degrees of sound. However, in open air (open baffle) configuration, the audio driver cannot generate significant acoustic output at frequencies below 200 Hz. Normally, one has to choose which system, open or closed baffle, to use. That is especially the case with portable audio players. Transporting two separate sets of speakers or audio drivers is not ideal for travel.

Accordingly, there exists the need for an audio player that can alternatively function in an open baffle free-air configuration, or a closed baffle configuration utilizing an hi-fi-grade active audio driver module for a boxed speaker, without compromising sound quality. It is, therefore, to the effective resolution of the aforementioned problems and shortcomings of the prior art that the disclosed technology is directed.

### SUMMARY OF THE DISCLOSED TECHNOLOGY

Aspects of the disclosed technology, according to some embodiments thereof, addresses an unfulfilled need in the prior art by providing an audio player that converts easily and quickly between an enclosure closed baffle audio driver system to a stand-alone open baffle audio driver system.

Accordingly, it is one object of the disclosed technology to provide an audio player comprising a plurality of audio drivers; controls for said audio drivers; and a means to power the audio player. Means to power the audio player in some embodiments is a rechargeable battery. The audio player my further comprise means for audio signal input and means for automatically detecting player environment, such that a mode of performance for the audio player switches between a first mode of performance and a second mode of performance. In addition, the audio player may comprise any one or more of: a housing for plurality of audio drivers, controls, rechargeable battery, means for audio signal input, means for detecting player environment and support attached to the housing.

Advantageously, the audio player disclosed herein is placed in a packed suitcase, can be transported anywhere, indoors or outdoors, while also having flexibility in baffle modes of performance. The audio player is removable and not permanently affixed to the suitcase, which is beneficial for air travel, where the TSA might ask that the audio player be removed. Another advantage rendered by the audio player disclosed herein is that it comprises audio drivers designed to operate in dipole (closed baffle) and box-less (open baffle) true 3D sonic experience modes.

In some embodiments, the means for audio signal input is a means for wireless connection or a socket to accept a wired plug. In some embodiments, the support is a plurality of supports, and one or more supports are movable between a first and second position. In some embodiments, the means for detecting player environment is a switch attached to the movable support such that when the support is in a first position the audio player is in a first mode of performance and when the support is in a second position, the audio player is in a second mode of performance. In some embodiments, the first mode of performance is an open baffle mode and the second mode of performance is a closed baffle mode. In some embodiments, in the first position the support is functional to hold the housing in a vertical position and in the second position the support is not functional to hold the housing.

It is also an object of the disclosed technology to provide a device for an audio player with the controls comprising at least one of an aperture with means for charging the player; an aperture with means for charging another device from said player; an aperture for audio signal input; means for changing volume; and means for adjusting audio variables of the audio player. In some embodiments, the audio player controls are in a compact central position on a front surface of the player housing. In some embodiments, the controls further comprise a plurality of apertures with means for charging the audio player; at least one aperture is on the front surface of the player; and at least one aperture is on a back surface of the player.

It is a further object of the disclosed technology to provide an enclosure for an audio player having four sides, a back, and an aperture at the front. Further to that, the audio player means for detecting player environment compliments the enclosure such that only a second mode of performance is possible while the player is in said enclosure. In some embodiments, the means for detecting player environment is a support movable between two positions and player only fits into said enclosure when support is in a second position, and said second position switches audio player to a closed baffle mode of performance.

Another advantage of the disclosed technology is to provide a suitcase enclosure for the audio player. In some embodiments, the suitcase enclosure comprises any one or more of: a suitcase shell having wheels, handles attached to an outside surface, a hollow volume inside said shell, means to open and close said suitcase, a player aperture in the shell wherein the player aperture may have speaker grills on the outside surface the player aperture. In some embodiments, the player aperture is having a cradle inside the hollow volume for holding the player. In some embodiments, the cradle is sized to fit said player. In some embodiments, the suitcase enclosure comprises means adopted to hold the audio player in said cradle.

Advantageously, the audio player mechanically floats in the player cradle, and the player cradle is made of a soft material with air gaps, such that when the audio player is in the player cradle, there is minimal energy transfer from the audio player to the suitcase or the suitcase to the audio player, resulting in undiminished audio player sound quality. The cradle in some embodiments is a gasket made of rubber and the shell is made of polycarbonate material. Further, the suitcase wheels, handles and means to open and close are all configured to prevent sound resulting from vibration of these items to influence the player's sound quality. In addition, the speaker grill further comprises a control panel door such that opening of said control panel door on the suitcase gives access to controls on said player.

In some embodiments, the cradle of the suitcase has a plurality of protrusions attached to the cradle that fit the plurality of apertures on a front area of the audio player. Advantageously, the cradle has means for repelling water from inside the suitcase. In some embodiments, the suitcase shell and the audio drivers and controls of the audio player are made of water repellent material, such that when the player is in the cradle and the suitcase volume has content, said content is protected from liquid.

In some embodiments, the suitcase also comprises a removable water repellant seal member for placement in the cradle when said player is not in the cradle, such that when the removable seal member is in the cradle and the suitcase volume filled with content said content has protection from liquid.

According to some embodiments, there is provided an audio player comprising a housing, at least one audio driver housed within the housing, a control panel having at least one controller, at least one power source compartment and a performance mode switcher, wherein the audio player is configured to perform either a closed baffle performance mode and an open baffle performance mode, and wherein the performance switcher is configured to switch the performance of the audio player between the closed baffle performance mode and the open baffle performance mode.

According to some embodiments, the audio player further comprises at least one support, movable between a folded position and an open position.

According to some embodiments, the at least one support is movable between the folded position and the open position by turning it clockwise or counterclockwise around a pivot attaching it to the housing.

According to some embodiments, the at least one support is configured to switch between the closed baffle performance mode when in the folded position, and the open baffle performance mode when in the open position.

According to some embodiments, the at least one controller comprises a dedicated controller, configured to control the performance mode switcher.

According to some embodiments, the audio player further comprises at least one power supply socket.

According to some embodiments, the audio player further comprises a USB socket.

According to some embodiments, the audio player further comprises at least one communication component.

According to some embodiments, the communication components is a wireless communication component.

According to some embodiments, the audio player further comprises at least one audio driver compartment protruding from the housing, configured to house at least a portion of the at least one audio driver.

According to some embodiments, the at least one audio driver comprises at least one tweeter driver and at least one woofer driver.

According to some embodiments, the performance mode switcher is controlled by a sensor.

According to some embodiments, there is provided a suitcase for the audio player comprising a shell having an access opening and a player cradle attached to the shell, shaped and sized to accommodate the audio player therein, wherein the access opening is configured to provide access to at least a portion of audio player when housed within player cradle.

According to some embodiments, the shell further comprises a suitcase grill and at least one grill frame attached to the suitcase grill.

According to some embodiments, the suitcase further comprises a player control panel cover attachable to the shell or to the player cradle, configured to switch between a covering position and an uncovering position.

According to some embodiments, the player cradle further comprises at least one plug configured to attach to and provide water proof sealing to at least one socket of the audio player.

According to some embodiments, the suitcase further comprises a fastener configured to fasten the player cradle to the shell.

According to some embodiments, the fastener is removably attached to the shell.

According to some embodiments, the performance mode switcher is configured to switch to the closed baffle performance mode when the audio player is accommodated within the player cradle.

According to some embodiments, the suitcase further comprises at least one movable element selected from the group of: at least one wheel, at least one handle and at least one means to open and close the suitcase.

According to some embodiments, the at least one means to open and close the suitcase is selected from the group of: at least one lock, at least one hinge and at least one zipper.

According to some embodiments, the at least one movable element is fitted with components configured to suppress rattle or vibration. The components selected from the group of: springs, gaskets, sponges and felt.

According to some embodiments, there is provided an enclosure for the audio player comprising a rear panel, and a circumferential body comprising at least one connection feature, the connection feature configured to enable the audio player to removably attach thereto.

According to some embodiments, there is provided an enclosure for the audio player comprising a rear panel, a circumferential body comprising at least one connection feature, the connection feature configured to enable the audio player to removably attach thereto, and at least one recess formed to accommodate the at least one support only in the folded position.

Certain embodiments of the present invention may include some, all, or none of the above advantages. Further advantages may be readily apparent to those skilled in the art from the figures, descriptions, and claims included herein. Aspects and embodiments of the disclosed technology are further described in the specification herein below and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1a constitutes a perspective rear view of an audio player, according to some embodiments.

FIG. 1b constitutes a perspective front view of an audio player, according to some embodiments.

FIG. 2 constitutes a perspective front view of an audio player with one grill removed, according to some embodiments.

FIG. 3a constitutes a bottom view of an audio player with supports in a folded position, according to some embodiments.

FIG. 3b constitutes a bottom view of an audio player with one support moving to the open position, according to some embodiments.

FIG. 4a constitutes a top view of an audio player with supports in an open position, according to some embodiments.

FIG. 4b constitutes a side view of an audio player with supports in an open position, according to some embodiments.

FIG. 5 constitutes a perspective view of an audio player placed in a suitcase, according to some embodiments.

FIG. 6a constitutes an exploded view in perspective of components of a suitcase and a player cradle, according to some embodiments.

FIG. 6b constitutes a top front perspective view of an audio player placed in a suitcase, according to some embodiments.

FIG. 6c constitutes a top back perspective view of the audio player cradle.

FIG. 6d constitutes a top view of an audio player placed in a suitcase, according to some embodiments.

FIG. 6e constitutes a bottom view without a suitcase in the way of the bottom view of the player cradle, according to some embodiments.

FIG. 6f constitutes a front view of an audio player placed in a suitcase, according to some embodiments.

FIG. 6g constitutes a rear view of an audio player placed in a suitcase, according to some embodiments.

FIG. 6h constitutes a right side view of an audio player placed in a suitcase, the opposite side being a mirror image thereof, according to some embodiments.

FIG. 7 constitutes a view in perspective of a player cradle, according to some embodiments.

FIG. 8 constitutes a perspective view of an audio player placed in a player cradle of within a suitcase, according to some embodiments.

FIG. 9 constitutes a perspective view of an audio player placed in a player cradle of a suitcase, with a fastener securing the back of the player cradle, according to some embodiments.

FIG. 10 constitutes a perspective view of a suitcase in a closed position, according to some embodiments.

FIG. 11 constitutes a perspective view of an enclosure for an audio player, according to some embodiments.

FIG. 12a constitutes a side view of an audio player attached to an enclosure according to some embodiments.

FIG. 12b constitutes a perspective view of an audio player attached to an enclosure according to some embodiments.

### DETAILED DESCRIPTION OF SOME EMBODIMENTS

The ensuing detailed description provides explanation of various aspects of the disclosed technology. The purpose of this explanation is to provide a thorough understanding of the different aspects of the disclosed technology. This description is not intended to limit the scope, applicability, or configuration of the disclosed technology. It will also be apparent to one skilled in the art that the disclosure may be practiced without specific details being presented herein. Various changes may be made in the function and arrangement of elements without departing from the spirit and scope of the disclosed technology as set forth in the appended claims. Furthermore, well-known features may be omitted or simplified for clarity.

To aid in describing the disclosed technology, directional terms may be used in the specification and claims (e.g upper, lower, left, right, etc.). These directional definitions are merely intended to assist in describing and claiming the disclosed technology and are not intended to limit the disclosed technology in any way. In addition, reference numerals that are introduced in the specification in association with a drawing figure may be repeated in one or more subsequent figure without additional description in the specification, in order to provide context for the other features.

The terms “suitcase” and “luggage”, as used herein, are interchangeable.

The terms “player” and “audio player”, as used herein, are interchangeable.

The term “substantially vertical” as used herein, means a position greater than 0 and up to 90 degrees from horizontal.

The term “plurality” as used herein, means more than one.

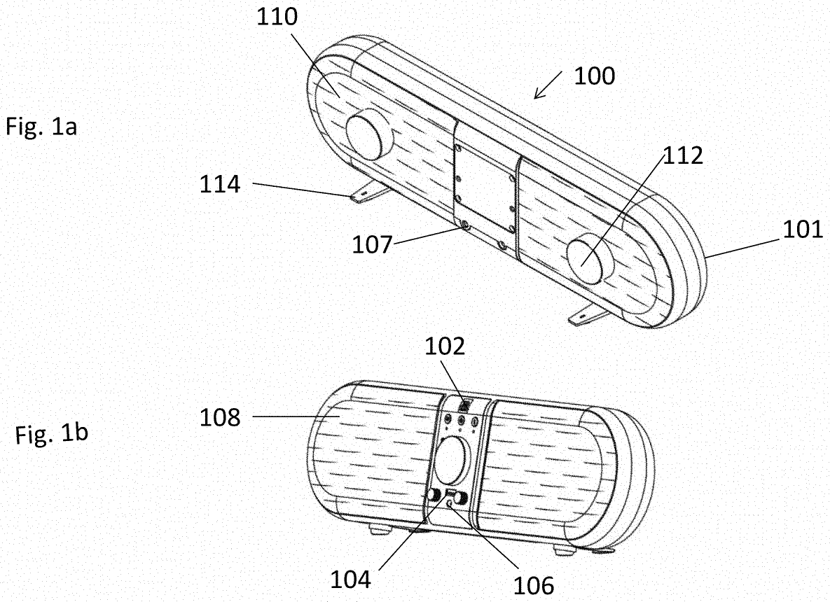

According to some embodiments, there is provided an audio player 100. FIGS. 1a and 1b show audio player 100. According to some embodiments audio player 100 comprises a housing 101. According to some embodiments, audio player 100 further comprises a control panel 102 having at least one controller (not numbered) configured to enable an operator of audio player 100 to control at least one functionality thereof. It will be clear that any controller-types known in the art are applicable, such as, but not limited to: a switch, a button, a knob, a lever, a touch-interface, a proximity sensor, and an auditory controlled command receiver.

According to some embodiments, control panel 102 is formed as a part of housing 101. According to some embodiments, control panel 102 is attached to housing 101.

According to some embodiments, audio player 100 further comprises at least one front speaker grill 108 (such as the two front speaker grills 108 depicted in FIG. 1b) and at least one rear speaker grill 110 (such as the two rear speaker grills 110 depicted in FIG. 1a). According to some embodiments, speaker grills 108 and 110 are made of metal with a fabric covering the metal.

According to some embodiments, audio player 100 comprises a power source compartment, configured to house at least one power source (not shown). According to some embodiments, power source compartment is housed within housing 101. According to some embodiments, the power source compartment is configured to house at least one disposable power source, such as a battery. According to some embodiments, the power source compartment is configured to house at least one rechargeable power source, such as a rechargeable battery.

According to some embodiments, audio player 100 further comprises at least one power supply socket, configured to connect with a power charging or power supplying cable (not shown). According to some embodiments, the at least one power supply socket comprises front power supply socket 106. According to some embodiments, control panel 102 comprises front power supply socket 106 (see FIG. 1b).

According to some embodiments, the at least one power supply socket comprises rear power supply socket 107 (see FIG. 1a). According to some embodiments, the power supply socket comprises both front power supply socket 106 and rear power supply socket 107.

According to some embodiments, audio player 100 further comprises USB socket 104. According to some embodiments, control panel 102 comprises USB socket 104. According to some embodiments, USB socket 104 is configured for receiving a USB cable (not shown). According to some embodiments, the USB cable, when connected to USB socket 104, serves as a power charging cable in a similar manner described hereinabove. According to some embodiments, USB socket is configured to receive a USB device for retrieving data therefrom, writing data thereto, or both. The USB device can be connected to the USB socket either directly or via a USB cable.

According to some embodiments, audio player 100 further comprises at least one communication component (not shown), adapted for communicating with one or more remote or external systems.

According to some embodiments, at least one communication component is a wireless communication component, configured to communicate with at least one remote system using a wireless communication protocol as known in the art.

According to some embodiments, at least one communication component is a wired communication component, configured to communicate with at least one external system using wired communication protocol as known in the art. According to some embodiments, wired communication component is configured to connect with at least one external system via USB socket 104.

Audio player 100 further comprises at least one audio driver (not shown). According to some embodiments, at least one audio driver comprises a magnetic drive. According to some embodiments, audio player 100 further comprises at least one audio driver compartment 112, protruding from housing 101. Each audio driver compartment 112 is configured to house at least a portion of an audio drive, for example, to house the magnetic drive of a corresponding audio drive. FIG. 1a depicts an exemplary audio player 100 comprising two audio driver compartments 112, housing two magnetic drive of two corresponding audio drives (hidden from view). Advantageously, audio driver compartments 112 protruding from housing 101 allow the overall depth of the audio player 100 (defined as the distance between the at least one front speaker grill 108 and the at least one rear speaker grill 110) to have a narrow front to back footprint.

According to some embodiments, audio player 100 further comprises at least one support 114, movable between a folded position and an open position. FIG. 1a depict an exemplary audio player 100 comprising two support 114, shown in an open position. Supports 114, when in the open position, are configured to hold audio player 100 in a substantially vertical position when used as a freestanding device without an being supported by an external enclosure.

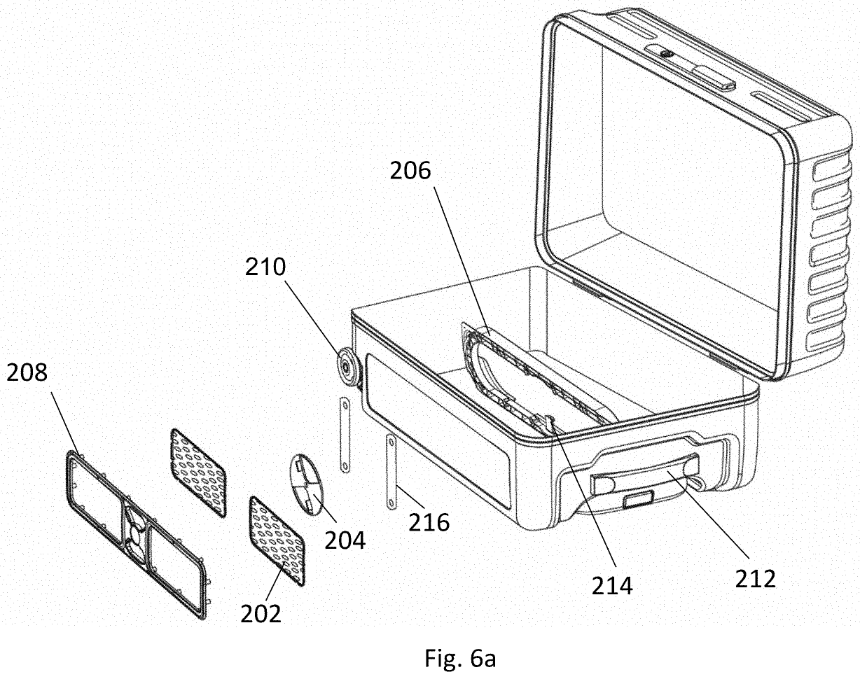

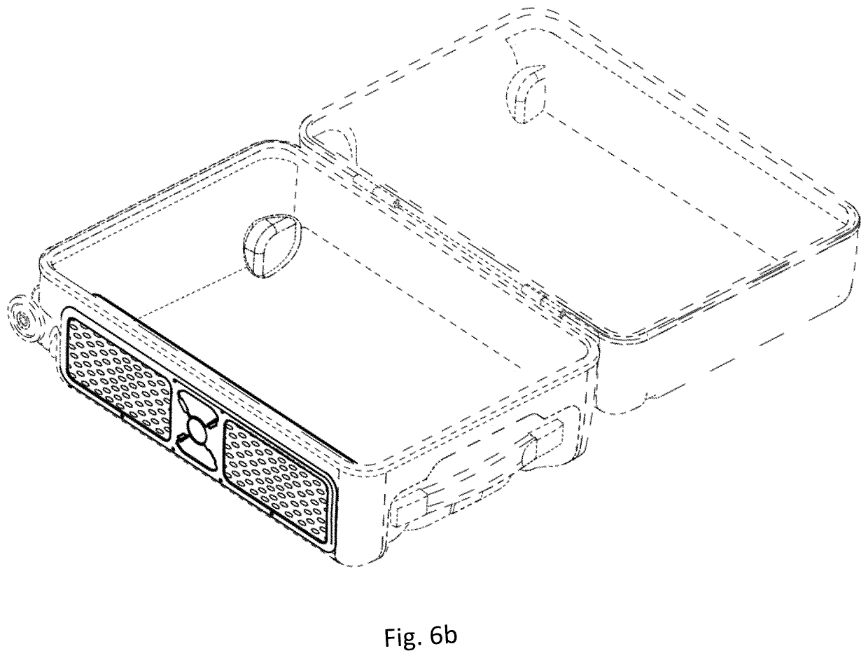

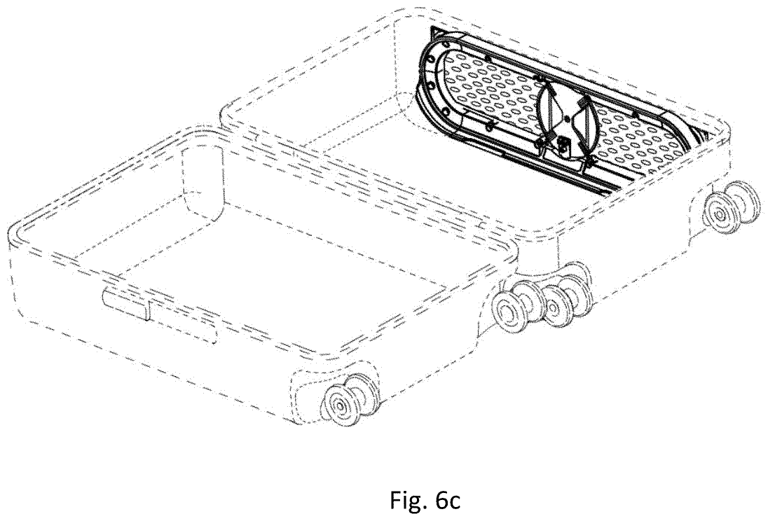

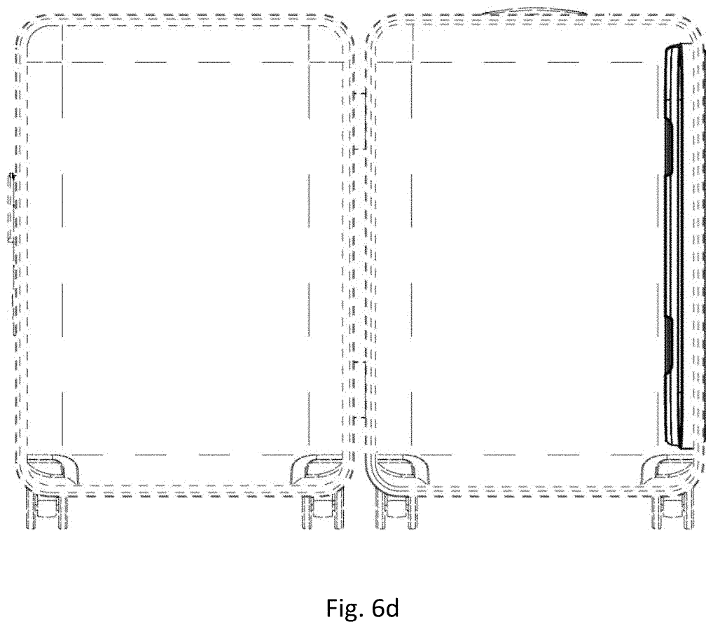

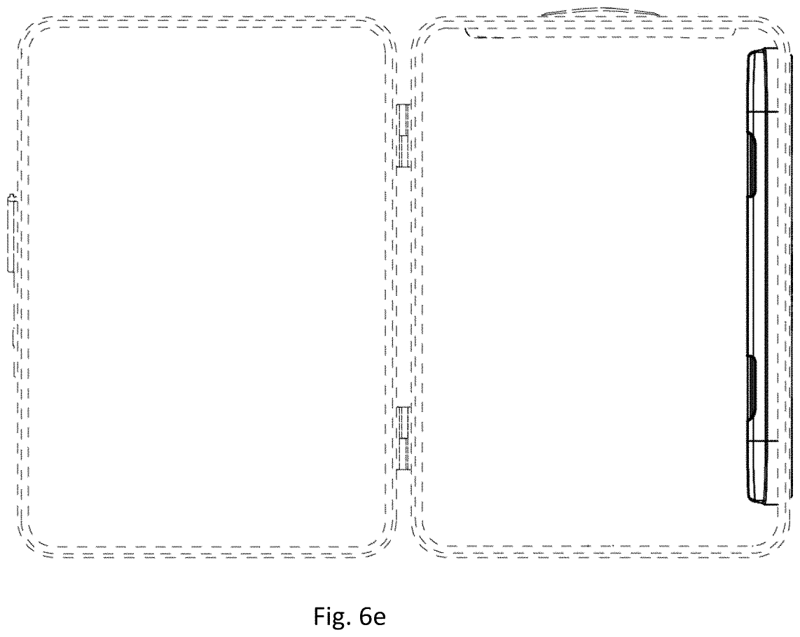

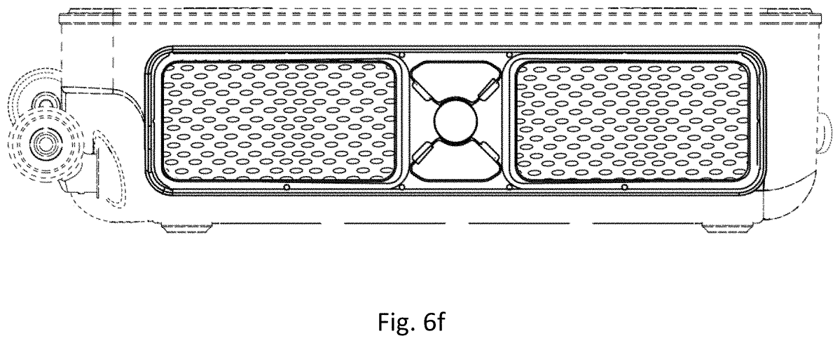

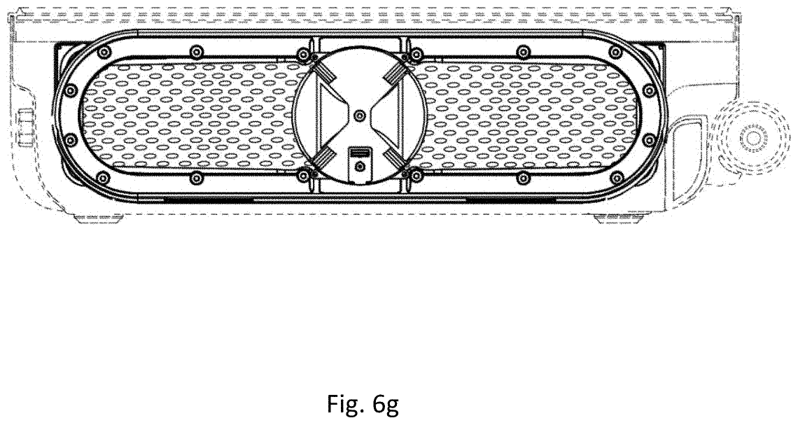

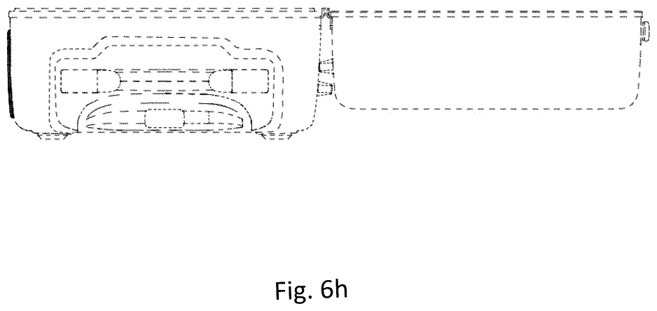

According to some embodiments, audio player 100 is water-resistant when at least one plug 214 (See FIG. 6) is used to attach to and provide water-proof sealing of the sockets thereof, such as USB socket 104 and front power supply socket 106. According to some embodiments, at least one plug is used to further attach to and seal rear power supply socket 107.

According to some embodiments, control panel 102 comprises rubber. According to some embodiments, control panel 102 is made of aluminum, rubber and acrylonitrile butadiene styrene. According to some embodiments, the rubber of the control panel has water resistant properties.

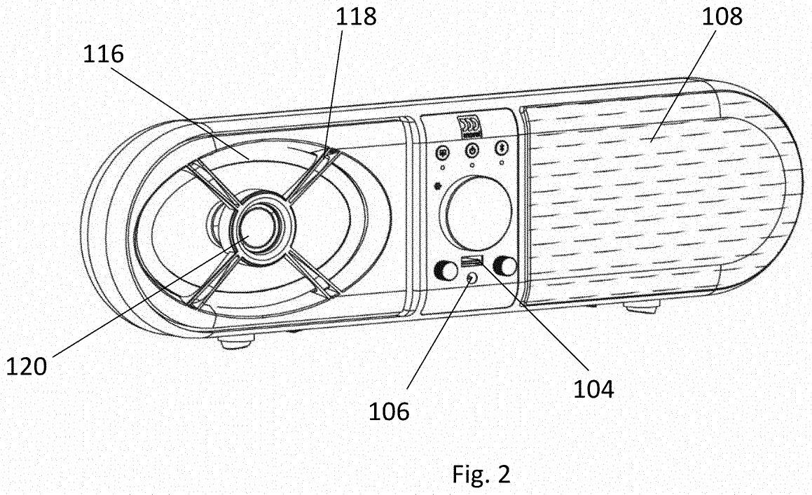

According to some embodiments, audio player 100 comprises a plurality of audio drivers. FIG. 2 details an exemplary configuration of two audio drivers 116 and 120 positioned in one side of audio player 100 relative to control panel 102. In some embodiments, audio driver 100 comprises four audio drivers, namely two audio drivers 116 and 120 positioned on either side of thereof relative to control panel 102.

According to some embodiments, audio player 100 comprises at least one midrange woofer driver 116. According to some embodiments, audio player 100 further comprises at least one tweeter driver 120 suspended above a corresponding midrange woofer driver 116 by bracket 118. According to some embodiments, each woofer driver 116 and a corresponding tweeter driver 120 reside on the same axis.

According to some embodiments, audio drivers 116 and 120 of audio player 100 are covered with water resistant materials, such as water resistant cloth or paper.

According to some embodiments, audio player 100 is configured to perform either a closed baffle performance mode and an open baffle performance mode.

According to some embodiments, audio player 100 comprises a performance mode switcher (not numbered), configure to switch the performance audio player 100 between a closed baffle performance mode and an open baffle performance mode.

According to some embodiments, audio player 100 comprises a Digital Signal Processor (DSP), and performance mode switcher is configured to switch the performance of the DSP between a closed baffle performance mode and an open baffle performance mode.

According to some embodiments, performance mode switcher comprises a micro switch configured to switch between both modes of performance upon detection of a switching signal.

According to some embodiments, performance mode switcher is controlled by a dedicated controller positioned on control panel 102. According to some embodiments, performance mode switcher is controlled by a sensor, such as a proximity sensor, configured to detect whether audio driver 100 is placed within an external enclosure. According to some embodiments, performance mode switcher is controlled by the position of at least one support 114.

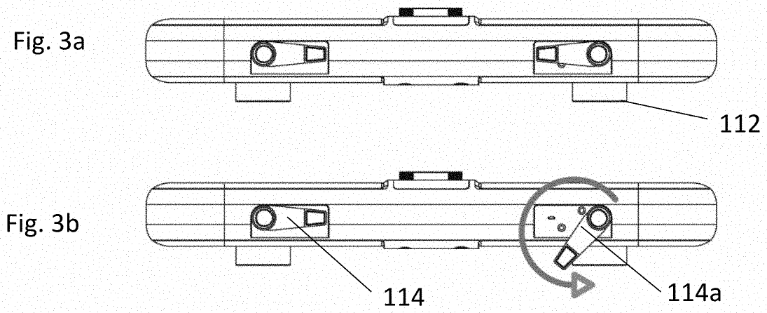

FIGS. 3a and 3b depict folded and open positions of supports 114 FIG. 3a shows an exemplary embodiment of an audio player 100 having two supports 114, positioned in a folded position.

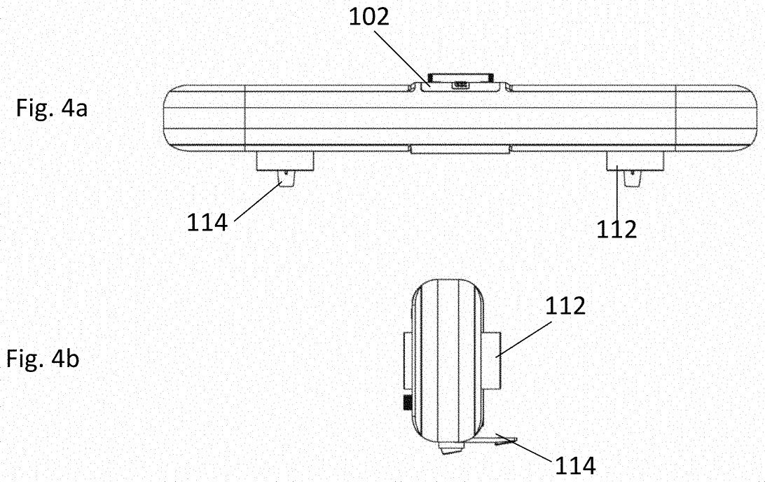

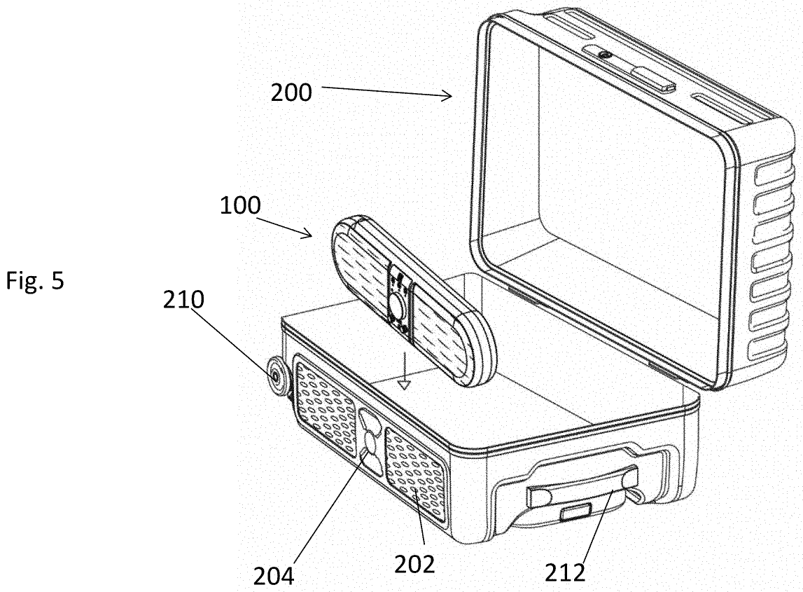

According to some embodiments, at least one support 114 is movable between a folded position and an open position by turning it clockwise or counterclockwise (see FIG. 3b) around a pivot or hinge attaching it to housing 101. FIGS. 4a and 4b depict a top view and a side view of audio player 100 having two supports 114, positioned in an open position.

According to some embodiments, at least one support 114 is movable between a folded and an open position by pulling or pushing it into or out of each position (embodiments not shown).

Advantageously, moving or displacing at least one support 114, preferably all support 114, between the folded and open position, provides audio driver 100 with a compact configuration, such that it can be conveniently inserted into or placed within a player cradle 206 (see FIG. 8) when in the folded position, and provides support to hold audio driver 100 in a substantially vertical position, for example when audio driver 100 is placed outside of an external enclosure, when in the open position.

According to some embodiments, at least one support 114 is configured to control performance mode switcher, mainly to switch the performance of audio player 100 between a closed baffle performance mode and an open baffle performance mode. In an exemplary embodiments depicted in FIG. 3b, support 114a is configured to switch the performance of audio player 100 to the open baffle performance mode when moved to the open position, and to switch to the closed baffle performance mode when moved to the folded position.

Advantageously, the at least one support 114 being used both for switching between position and for controlling the performance mode switcher, renders such switching to being automatic and transparent to the user. This automation is achieved by recognizing that a folded position indicates that audio driver 100 is placed or is about to be placed within a player cradle 206 or other external enclosure, therefore it should operate in the closed baffle performance mode, and that an open position indicates that audio driver 100 is used outside on an external enclosure, and therefore should operate in the open baffle performance mode.

According to some embodiments, at least one controller is configured to control switching on or switching off audio player 100. According to some embodiments, at least one controller is configured to control functionality of at least one audio driver. According to some embodiments, at least one controller is configured to control sound volume. According to some embodiments, at least one controller is configured control switching between a closed baffle performance mode and an open baffle performance mode.

Referring now to FIG. 5, an audio player 100 is configured for placement into suitcase or luggage 200. Suitcase 200 is different from old and well-known versions in a few ways. According to some embodiments of suitcase 200, any parts of the suitcase 200 that is prone to rattle and have sounds of vibration associated with the rattle, are fitted with sound suppressing items or materials.

According to some embodiments, suitcase 200 comprises at least one movable part movable element selected from the groups of: at least one wheel 210, preferably a plurality of wheels 210, at least one handle 212, preferably a plurality of handles 212, and means to open and close shell 222.

According to some embodiments, means to open and close shell 222 is selected from the group of: at least one lock, at least one hinge and at least one zipper.

According to some embodiments, at least one movable element of suitcase 200 is fitted with components configured to suppress such a rattle or vibration. According to some embodiments, components configured to suppress such a rattle or vibration are selected from the group of: springs, gaskets, sponges, felts and the like. According to some embodiments, other cushioning components or materials known in the art may be used to suppress rattle or vibration. Any vibration from the at least one movable element might impact the sound emanating from audio player 100. Vibration adds a low frequency sound that disturbs the acoustic balance, so it is imperative to reduce any sound of vibration.

The connection of audio player 100 to suitcase 200 must also minimize vibration and energy transfer from one to the other. Energy transfer from audio player 100 to suitcase 200 and the opposite energy transfer is controlled and minimized. According to some embodiments, such energy transfer is controlled by mechanically floating audio player 100 in player cradle 206.

The term “mechanically floating”, as used herein, refers to a connection of two items that is not rigid and leaves room for movement such that there is no energy transfer. The connection of audio player 100 to player cradle 206 is not a rigid connection. The Audio player 100 is held securely but not rigidly in player cradle 206. Player cradle 206 in some embodiments is formed as a rubber gasket having air gaps in the rubber, thereby creating a cushioned and floating like environment for audio player 100.

According to some embodiments, suitcase 200 comprises shell 222, formed as a container that can be opened and closed. According to some embodiments, the shell 222 is made of polycarbonate material and aluminum as the frame. However, any well know material used in luggage construction is a viable substitute.

FIG. 6a constitutes an exploded view in perspective of suitcase 200 and player cradle 206, according to some embodiments. FIGS. 6b-6h constitute different views of player cradle 206 placed in suitcase 200. According to some embodiments, player cradle 206 is attached to at least a portion of shell 222. According to some embodiments, player cradle 206 is fixedly attached to at least a portion of shell 222. player cradle 206 is removably attached to at least a portion of shell 222.

According to some embodiments, player cradle 206 is shaped and sized to accommodate audio player 100 therein. According to some embodiments, shell 222 comprises an access opening (not numbered), configured to provide access to at least a portion of audio player 100 when housed within player cradle 206.

In the exemplary embodiment in FIGS. 6a-6h, shell 222 further comprises suitcase grill frame 208 and at least one support grill 202 configured to attach to suitcase support frame 208 (FIGS. 6a-6h depict two support grills). According to some embodiments, suitcase 200 further comprises player control panel cover 204 attachable to shell 222 or to player cradle 206. According to some embodiment, at least one of: suitcase grill frame 208 and player control panel cover 204, are removably attached to shell 222. According to some embodiments, at least one support grill 202 is removably attached to grill frame 208.

According to some embodiments, at least one support grill 202 is made of metal and suitcase grill frame 208 is made of a rigid plastic material, with one example being ABS material. According to some embodiments, player cradle 206 is a gasket. According to some embodiments, player cradle 206 is made of rubber. According to some embodiments, player cradle 206 further comprises at least one plug 214.

According to some embodiments, player cradle 206 is configured to fulfill the same function when placed anywhere along shell 222. According to some embodiments, player cradle 206 is configured to fulfill the same function when placed anywhere along the inner circumference of suitcase 200. According to some embodiments, player cradle 206 is configured to fulfill the same function when placed anywhere along the outer circumference of suitcase 200.

According to some embodiments, the shape and size of player 100 are configured to match or be accommodated in player cradle 206.

According some embodiments, audio player 100, when housed in player cradle 206, is sized to occupy about 5 to 10 percent of the internal volume of luggage 200. This leaves room for desired personal items of a traveler.

According to some embodiments, the material for player cradle 206, at least one plug 214 and suitcase 200 is water resistant such that the contents of the suitcase 200 and the rear side of the audio player 100 are protected from liquids. According to some embodiments, at least plug 214 is a made of rubber.

A user has a choice to use suitcase 200 without audio player 100. According to some embodiments, when audio player 100 is not in suitcase 200, a suitcase seal member sized and shaped to match an audio player 100 (not shown) is placed in player cradle 206 of suitcase 200, such that suitcase 200 has retains similar water resistance features. According to some embodiment, the suitcase seal member is made of soft polycarbonate, but any well-known material in the art of luggage is sufficient to use as the suitcase seal member.

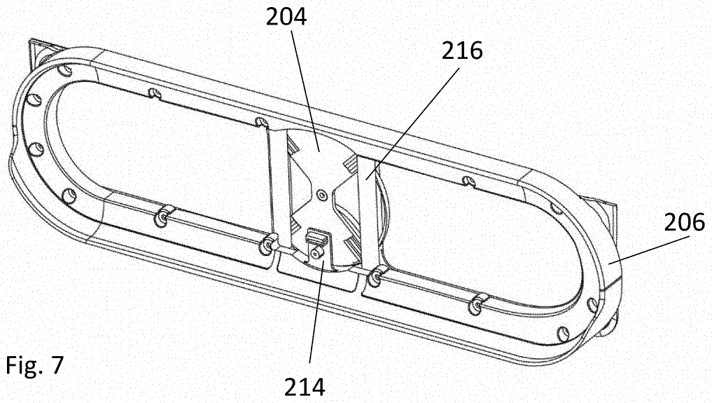

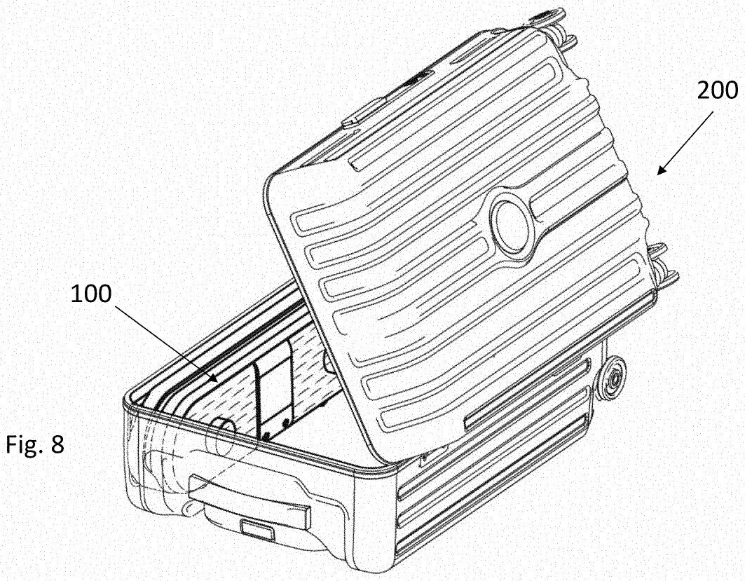

FIG. 7 shows a perspective view of the player cradle 206. According to some embodiments, player cradle 206 comprises at least one column segment 216, preferably two column segments 216, configured to connect control panel cover 204 to player cradle 206. According to some embodiments, at least one column segment 216 further comprises either protrusions or apertures (not shown) for matching apertures or protrusions (not shown) on control panel cover 204.

According to some embodiments, control panel cover 204, when attached to player cradle 206 or to shell 222, is configured to switch between a covering position, in which it covers and prevents access to control panel 102, and an uncovering position, in which is provides access to at least one controller of control panel 102. According to some embodiments, matching protrusion and apertures between control panel cover 204 and player cradle 206 are configured to retain control panel cover 204 in either a covering or an uncovering position.

According to some embodiments, other methods for attaching control panel cover 204 to either player cradle 206 or to shell 222 may be used, such as, but not limited to: hinges, snap-fit, sliding within rails and the like.

According to some embodiments, any other well know mechanism to switch control panel cover 204 between a covering or an uncovering position is used.

According to some embodiments, suitcase 200 comprises a fastener 218, configured to fasten player cradle 206 to shell 222. According to some embodiments, fastener 218 is attached to shell 222 at least at one end thereof. According to some embodiments, fastener 218 is removably attachable to suitcase 200.

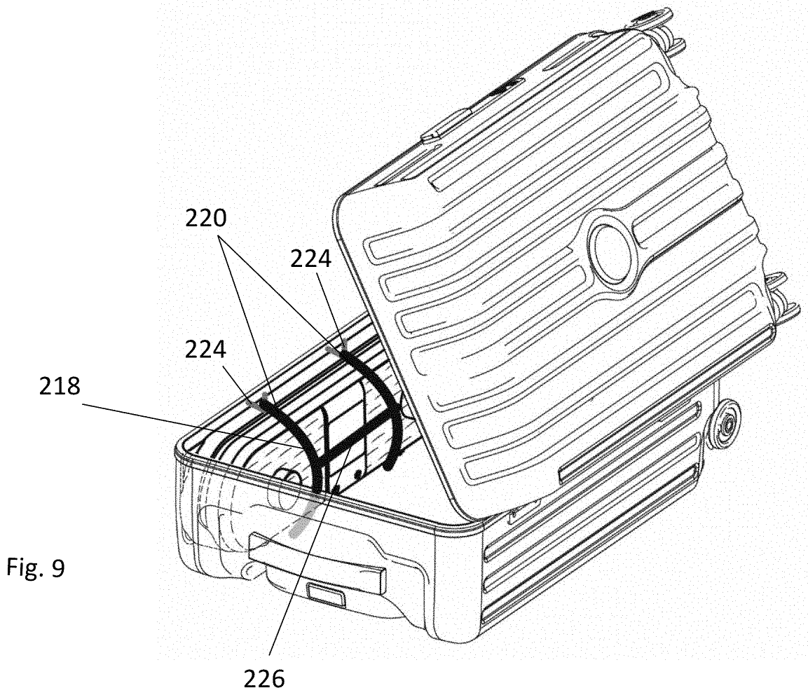

FIG. 8 shows an exemplary suitcase 200 with audio player 100 retained in player cradle 206 before placement of fastener 218 (depicted in FIG. 9). According to some embodiments, fastener 218 is made of rubber.

According to some embodiments, fastener 218 comprises at least one belt 220, wherein a first end (not numbered) of at least one belt 220 is permanently attached to shell 222. According to some embodiments, fastener 218 comprises at least two belts 220 (see FIG. 9), wherein a first end of each belt 220 is permanently attached to the luggage shell 222. The attachment of at least one belt 220 to the shell of suitcase 200 is by any well-known means in luggage technology, such as, but not limited to: riveting, gluing, sewing and the like.

According to some embodiments, shell 222 further comprises at least one belt connector 224, such that a second end (not numbered) of at least one fastener 218 is configured to attach to a matching belt connector 224, for example via a hook, thereby fastening fastener 218 to shell 222 around at least a portion of player cradle 206. According to some embodiments, the amount of belt connectors 224 matches the amount of belt connectors 224.

At least one belt connector 224 may be provided as any type of connector known in the art, such as any releasable connector.

According to some embodiments, fastener 218 further comprises horizontal belt 226 positioned between and connected to adjacent belts 220. According to some embodiments, player cradle 206 is formed as a rubber gasket having a thickness of at least 3 mm. According to some embodiments, player cradle 206 is formed as a foam piece.

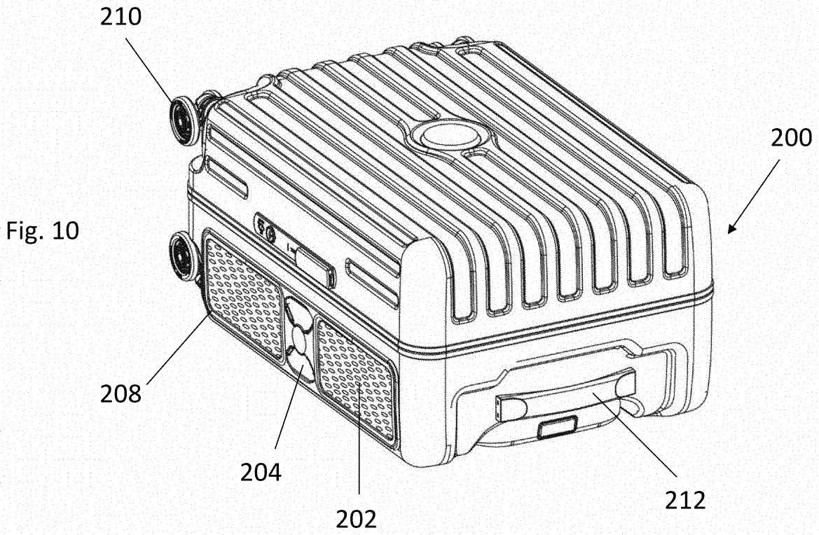

FIG. 10 depicts suitcase 200 in a closed position, wherein audio player 100 may be either placed inside or outside of suitcase 200.

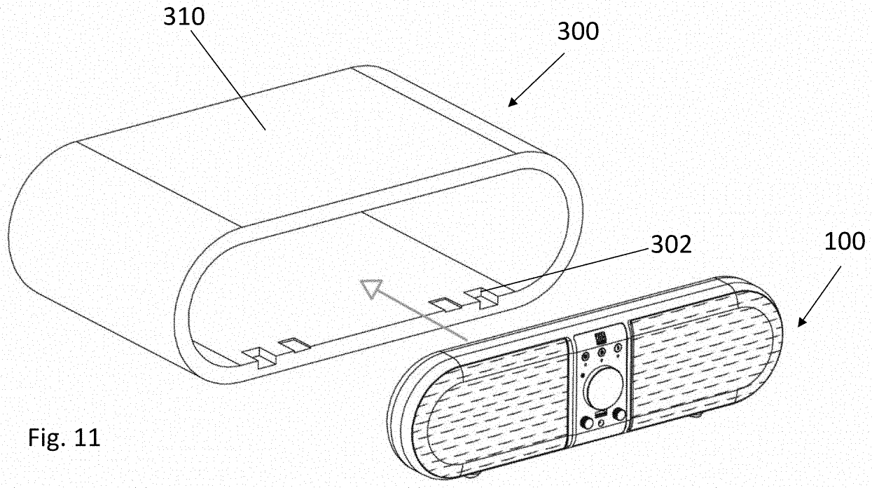

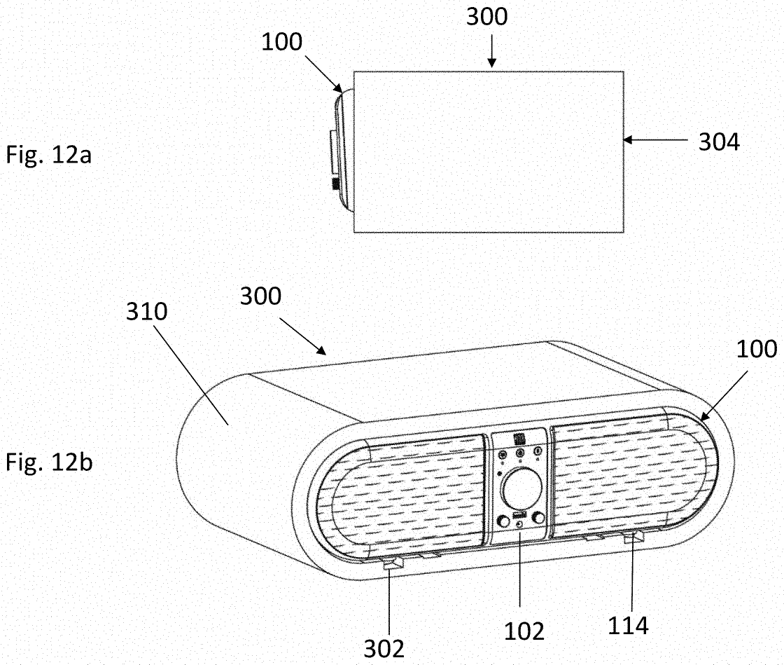

According to some embodiments, player 100 is can be housed in external containers, which are not limited to suitcase 200. FIG. 11 illustrates an enclosure 300 connectable to audio player 100 at a front end thereof. Enclosure 300 comprises circumferential body 310 and rear panel 304 (shown in FIG. 12).

Enclosure 300 is configured to removably connect with audio player 100 at an opposite end to rear panel 304. According to some embodiments, circumferential body 310 comprises at least one connection feature, configured to enable audio player 100 to removably attach thereto. According to some embodiments, enclosure 300 at least one recess 302, configured to accept at least one matching support 114 of audio player 100, thereby retaining audio player 100 in a secured position, i.e. attached to enclosure 300.

According to some embodiments, enclosure 300 is sized and shaped to match audio player 100 attachable thereto. According to some embodiments, enclosure 300 is configured to seamlessly support switching between a closed baffle performance state and an open baffle performance state. According to some embodiments, at least one recess 302 is formed to accommodate the at least one support 114 only in a folded position, (see FIG. 11), thereby attaching to audio player 100 when in a closed baffle performance state. FIGS. 12a and 12b show audio player 100 attached to enclosure 300, in a side and a prospective front view, respectively.

According to some embodiments, audio player 100 is removably attachable to enclosure 300 via other removable attachment means known in the art, such as press-fit, magnetic attachment and the like.

Audio players 100 and external enclosures designed specifically for them, such as suitcase 200 or enclosure 300, provide the capability to interchange speaker or audio driver types. For example, speakers of higher quality or varying ranges could be substituted for existing ones, in home entertainment systems or automobile audio systems, with minimal effort.

It is appreciated that certain features of the disclosed technology, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1.-24. (canceled)

25. An audio player comprising:
a housing;
at least one audio driver housed within the housing;
a control panel having at least one controller;
at least one power source compartment; and
a performance mode switcher;
wherein the audio player is configured to perform either a closed baffle performance mode and an open baffle performance mode, and
wherein the performance switcher is configured to switch the performance of the audio player between the closed baffle performance mode and the open baffle performance mode.

26. The audio player according to claim 25, further comprising at least one support, movable between a folded position and an open position.

27. The audio player according to claim 26, wherein the at least one support is movable between the folded position and the open position by turning it clockwise or counterclockwise around a pivot attaching it to the housing.

28. The audio player according to claim 26, wherein the at least one support is configured to switch between the closed baffle performance mode when in the folded position, and the open baffle performance mode when in the open position.

29. The audio player according to claim 25, wherein the at least one controller comprises a dedicated controller, configured to control the performance mode switcher.

30. The audio player according to claim 25, further comprising at least one of: a power supply socket, a USB socket, a wired communication component, and/or a wireless communication component.

31. The audio player according to claim 25, further comprising at least one audio driver compartment protruding from the housing, configured to house at least a portion of the at least one audio driver.

32. The audio player according to claim 25, wherein the at least one audio driver comprises at least one tweeter driver and at least one woofer driver.

33. The audio player according to claim 25, wherein the performance mode switcher is controlled by a sensor.

34. A suitcase for the audio player of claim 25, comprising:
a shell comprising an access opening; and
a player cradle attached to the shell, shaped and sized to accommodate the audio player therein;
wherein the access opening is configured to provide access to at least a portion of audio player when housed within player cradle.

35. The suitcase according to claim 34, wherein the shell further comprises a suitcase grill and at least one grill frame attached to the suitcase grill.

36. The suitcase according to claim 34, further comprising a player control panel cover attachable to the shell or to the player cradle, configured to switch between a covering position and an uncovering position.

37. The suitcase according to claim 34, wherein the player cradle further comprises at least one plug configured to attach to and provide water proof sealing to at least one socket of the audio player.

38. The suitcase according to claim 34, further comprising a fastener configured to fasten the player cradle to the shell.

39. The suitcase according to claim 34, wherein the performance mode switcher is configured to switch to the closed baffle performance mode when the audio player is accommodated within the player cradle.

40. The suitcase according to claim 34, further comprising at least one movable element selected from the group of: at least one wheel, at least one handle and/or at least one means to open and close the suitcase.

41. The suitcase according to claim 40, wherein the at least one means to open and close the suitcase is selected from the group of: at least one lock, at least one hinge and/or at least one zipper.

42. The suitcase according to claim 40, wherein the at least one movable element is fitted with components configured to suppress rattle or vibration, the components selected from the group of: springs, gaskets, sponges and/or felt.

43. An enclosure for the audio player of claim 25, comprising:
a rear panel; and
a circumferential body comprising at least one connection feature, the connection feature configured to enable the audio player to removably attach thereto.

44. An enclosure for the audio player of claim 26, comprising:
a rear panel;
a circumferential body comprising at least one connection feature, the connection feature configured to enable the audio player to removably attach thereto; and
at least one recess formed to accommodate the at least one support only in the folded position.
